(19) United States
(12) Patent Application Publication
(10) Pub. No.: US 2005/0176874 A1
(43) Pub. Date: Aug. 11, 2005

(54) Dual cure emulsions

(76) Inventors: Carme Font i Panades, Sant Quirze del Valles (ES); Jordi Albalat Perez, Barcelona (ES)

Correspondence Address: WHYTE HIRSCHBOECK DUDEK S C, 555 EAST WELLS STREET, SUITE 1900, MILWAUKEE, WI, 53202, US

(21) Appl. No.: 10/515,442

(22) PCT Filed: May 31, 2002
(86) PCT No.: PCT/EP02/06096

(51) Int. Cl. C08K 3/00; B05D 3/02

(52) U.S. Cl. 524/556; 427/379

(57) ABSTRACT

The invention concerns an aqueous polymer dispersion composition comprising for 100 parts by weight of (A)+(B):(A) from 30 to 99 parts by weight of at least one dispersed polymer containing acetoacetoxy-type functional moieties, the said polymer having a glass transition temperature from 0 to 100° C.; and (B) from 1 to 70 parts by weight of a multifunctional acrylate, said aqueous composition further containing a volatile base in an amount sufficient to convert the acetoacetoxy functionalities of (A) to enamine ones. The invention does also concern a process of preparation, a coating composition comprising the said composition as a binder, its uses in industrial coatings and a dual cure process of coating.

The present invention relates generally to aqueous polymer dispersion compositions which are curable by exposure to radiation. Such aqueous compositions are useful in coatings, particularly in wood and plastic ones, plus inks and overprint varnishes. The present invention relates particularly to such radiation-curable compositions having a secondary curing mechanism which is not dependent upon exposure to radiation.

These aqueous polymer compositions comprise for 100 parts by weight of (A)+(B):
(A) from 30 to 99, preferably from 50 to 97, parts by weight of at least one dispersed polymer containing acetoacetoxy-type functional moieties, the said polymer having a glass transition temperature from 0 to 100° C. ; and
(B) from 1 to 70, preferably from 3 to 50, parts by weight of at least one multifunctional acrylate, preferably pre-dispersed in water,
   said aqueous composition further containing a volatile base in an amount sufficient to convert the acetoacetoxy functionalities of (A) to enamine ones. The said acetoacetoxy groups are pending groups (attached to the polymer backbone) with general formula (I): 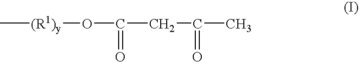
   wherein
   y is 0 or 1; and 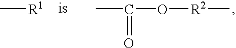
   preferably a C₂-C₄ alkylene radical.

There is an increasing need for high performance coatings free from volatile organic compounds (VOC). In the particular field of Industrial Wood Finishing, VOC free, tack free before curing, open pore matt radiation curable coatings are difficult to obtain with the existing radiation curable systems.

Radiation curable dispersions with these properties are therefore desired for many applications. On the other hand, other market demands for these kinds of coatings are: non-Xi labelling (skin non-irritation or sensitization), good sandability and high chemical resistance performances for the final coating, besides good filmification and coalescence performances in the absence of any coalescing agent for the aqueous dispersion of the invention.

EP-A1-0 486 278 discloses radiation curable dispersions which contain a non-radiation curable emulsion polymer and radiation curable meth(acrylates). EP-A2-0 736 573 discloses blends of non-radiation curable emulsion polymers having different Tg and radiation curable meth(acrylates).

With these dispersions the above mentioned requirements are not yet satisfactorily met.

It is an object of the present invention to provide radiation curable aqueous polymer dispersion compositions with low VOC, enabling the obtention of coatings without tack before radiation curing and with good sandability, high chemical resistance and good hardness performances after radiation curing besides good filmification performances of the said composition in the absence of coalescing agents.

In many aspects of the final coating performances, these compositions fulfill those of polyurethane dispersions for industrial finishing of wood surfaces, with the additional advantages to be significantly easier to obtain, less expensive and more environmentally friendly.

We have found that this objective is achieved by the aqueous composition as defined according to the present invention.

In an additional preferred embodiment, the novel aqueous polymer dispersion composition comprises:
60-95 parts by weight of at least one dispersed polymer (A) as defined above; and
5-40 parts by weight of at least one pre-dispersed multifunctional acrylate (B).

The stated weights are based on 100 parts by weight of (A)+(B).

The presence of a volatile base is essential in an amount sufficient to convert the acetoacetoxy moieties of at least one polymer (A) into enamine ones.

In case where the polymer (A) contains acidic carboxy groups, the amount of the volatile base must be sufficient to neutralize these acidic groups and to convert the acetoacetoxy groups into enamine ones.

The conversion of the acetoacetoxy functions of polymer (A) to enamine ones enables an efficient chemical blocking of the acetoacetoxy functions and to prevent their hydrolysis, which hydrolysis can render them ineffective regarding their participation in secondary curing mechanism according to the present invention.

According to the conditions of the present invention (presence of a volatile base), this chemical blocking of acetoacetoxy functions is reversible under drying conditions (evaporation of the base with water), thus enabling a regeneration of the acetoacetoxy functions for an efficient participation in the secondary curing reaction (Michael addition reaction) with a part of component (B) before the final radiation curing.

The acetoacetylated (bearing acetoacetoxy functions) polymer (A) has a content of acetoacetoxy functions from 0.0047 to 2.8, preferably from 0.14 to 1.87, and more preferably from 0.23 to 1.40, expressed in mmol per g of polymer (A). It may also bear acidic carboxy functions, corresponding to an acid value from 0 to 50, with this acid value expressed in mg of KOH per g of polymer (A).

Such a polymer (A) and the resulting aqueous polymer dispersion composition (comprising (A)+(B)) may be obtained by various methods such as:
(a) by an aqueous emulsion free-radical polymerization of a suitable monomeric composition comprising besides other monomers, at least one monomer bearing the acetoacetoxy groups and optionally at least one monomer bearing acidic carboxy groups. At the end of the emulsion polymerization, the volatile base is added in an amount sufficient to convert the acetoacetoxy groups into enamine ones (by pH adjustment). The aqueous polymer dispersion of polymer (A) may be used as such or after adjusting the solids content (dilution) if required before mixing with component (B) as such (to be dispersed) or in the predispersed form of an aqueous dispersion of (B);
(b) by a solution or bulk free-radical polymerization of the suitable monomeric composition as specified in (a), followed by its dispersion in water, in the presence of the volatile base in an amount sufficient to convert the acetoacetoxy groups into enamine ones. This aqueous dispersion can be used as in method (a) for preparing the final aqueous polymer dispersion of the invention (comprising (A)+(B)) ;
(c) by transesterification reaction, in solution and in the presence of a suitable transesterification catalyst, of a mixture of a hydroxylated polymer (OH functionality of at least 2), with a C₁-C₄ alkyl acetoacetate, thus enabling the incorporation of acetoacetozy groups in the said hydroxylated polymer. The aqueous dispersion of this polymer can be prepared under such conditions as disclosed for method (b), before introducing component (B), pre-dispersed in water or to be dispersed in the dispersion of (A);
(d) by mixing at least two aqueous dispersions of polymers (A), each one being obtained by one of methods (a) or (b) or (c) and then introducing component (B), as discussed above.

The polymer (A) as obtainable by methods (a) or (b) may be derived from a monomeric composition comprising for 100 weight parts of components (i)+(ii):
(i) 40-99.9, preferably 60-97, and more preferably 70-95, parts by weight of at least one main monomer selected from the group consisting of C₁-C₂₀ alkyl (meth)acrylates, vinyl esters of carboxylic acids of 2 to 20 carbon atoms, ethylenically unsaturated nitrites of 3 to 6 carbon atoms, vinylaromatics of up to 20 carbon atoms, vinyl halides, aliphatic hydrocarbons having 2-5 carbon atoms and one double bond, e.g. ethylenic unsaturation.
Preferred main monomers of type (i) are: C₁-C₈ alkyl (meth)acrylates, such as methyl (meth)acrylate, ethyl (meth)acrylate, n-propyl and isopropyl (meth)acrylate, n-butyl (meth)acrylate and 2-ethyl-hexyl (meth)acrylate, vinyl esters such as vinyl acetate and vinyl propionate, styrene and α-methylstyrene as vinylaromatics, vinyl halides, such as vinyl chloride or vinylidene chloride, and butadiene and isoprene as diolefins.
Particularly preferred main monomers are C₁-C₈ alkyl (meth)acrylates and styrene as well as mixtures thereof;
(ii) at least one acetoacetoxy functional monomer which may be present in an amount of 0.1-60, preferably 3-40, more preferably 5-30, parts by weight.
Acetoacetoxy functional monomers useful for the introduction of acetoacetoxy functionality may be selected from the group consisting of acetoacetoxyethyl acrylate, acetoacetoxypropyl methacrylate, allyl acetoacetate, acetoacetoxybutyl methacrylate, 2,3-di (acetoacetoxy)propyl methacrylate and the like. In general, any polymerizable hydroxy functional monomer can be converted into the corresponding acetoacetate by reaction with diketene or other suitable acetoacetylating agents.
A particularly preferred ethylenically unsaturated acetoacetoxy-type functional monomer is acetoacetoxyethylmethacrylate (“AAEM”);
(iii) 0 to 5, preferably 0 to 3, parts by weight of at least one crosslinking monomer.
Typically, these monomers crosslink during polymer formation without requirement of any curing technique. Such crosslinking monomers can be selected for example from ethylene glycol diacrylate, ethylene glycol dimethacrylate, allyl methacrylate and hexanediol diacrylate;
(iv) 0-5, preferably 0 to 3, parts by weight of at least one alpha-beta ethylenically unsaturated carboxylic acid or anhydride.
It may be selected from (meth)acrylic acid, maleic acid or anhydride, itaconic acid.
More preferably it is acrylic or methacrylic acid.

The nature and proportions of the monomers (i) to (iv) of which the polymer may be composed are chosen so that the polymer has a glass transition temperature from 0 to 100° C., preferably from 5 to 90° C., and more preferably, from 20 to 90° C.

According to method (c), the polymer (A) may be a modified hydrozylated polymer, which is modified by transesterification of C₁-C₄ alkyl acetoacetate. Such hydroxylated polymers with OH functionality of at least 2 may be selected from polyesters, polyetherpolyesters, polyester- and polyether-polyurethanes.

According to methods (a) or (b), the polymer can be prepared by solution polymerization or bulk polymerization with subsequent dispersing in water or by emulsion polymerization. Emulsion polymerization is the preferred one.

In the emulsion polymerization, the monomers can be polymerized in a conventional manner or in a multistage process, with possibility of core/shell structures, in the presence of a water soluble initiator and of an emulsifier, preferably at a polymerization temperature ranging from 30° C. to 95° C. The polymer can be also a blend of emulsions of individually formed polymers. In case of core/shell structure the acetoacetoxy groups may be present in both shell and core, at the same or different content, but in the range of the invention as defined above. The core and shell may have different Tg, but with each one being inside the range of Tg as defined above for the invention (0-100° C.

At the end of the process, the neutralization step must be carefully carried out by adding sufficient quantity of volatile base, preferably ammonia, in order to reach a stable pH>7.5 up to 10 and to assure the enamine formation by reacting the volatile base with the acetoacetoxy functionality.

Examples of suitable initiators are sodium persulfate, potassium persulfate, ammonium persulfate, tert-butyl hydroperoxide, water-soluble azo compounds and redox initiators.

Examples of emulsifiers used are alkali metal salts of relatively long-chain fatty acids, alkyl sulfates, alkyl sulfonates, alkylated arylsulfonates or alkylated diphenyl ether sulfonates. Other suitable emulsifiers are reaction products of alkylene oxides, in particular ethylene oxide or propylene oxide, with fatty acid alcohols, fatty acids or phenol or alkylphenols.

In the polymerization, regulators may be used for adjusting the molecular weight. For example, —SH— containing compounds, such as mercaptoethanol, mercaptopropanol, thiophenol, thioglycerol, thioglycolates, methyl thioglycolate, tert-dodecyl mercaptan and n-dodecyl mercaptan are suitable.

The novel aqueous composition contains a multifunctional acrylate (B) which may or may not be emulsified in the water of the polymer (A) dispersion. When so emulsified, it may be emulsified with the aid of surfactants as discussed above suitable in an emulsion polymerization process.

A wide variety of multi-functional acrylates having an acrylate functionality of at least 2, may be employed. They can be monomeric or oligomeric (up to Mn of 20000) or polymeric (up to Mn 10000). If polymeric ones are used then at least one monomeric one is present with.

The meaning of acrylate is restricted to acrylate function. Typical examples include:
1—Epoxy acrylates
2—Urethane and polyurethane acrylates
3—Multi-functional acrylate monomers
4—Amine-acrylate adducts
5—Polyester acrylates
6—Polyalkoxylated and polyether acrylates
7—Acrylated acrylic oligomers
8—Acrylated SMA or S (M) AA (styrene-maleic anhydride or styrene-(meth)acrylic acid oligomers).
   1—Epoxy acrylates are those products formed by the reaction of acrylic acid with an epoxy (glycidyl) functional component e.g. aliphatic and aromatic containing epoxy resins, epoxidised oils, acrylic polymers and acrylic grafted polymers in which the acrylic component contains pendent epoxy groups. Some of the acrylic acid may be replaced by other acids, both ethylenically unsaturated and saturated, so as to impart specific properties e.g. aliphatic acids, fatty acids and aromatic acids.

These products may alternatively be prepared by the reaction of a carboxylic acid functional component (e.g. polyesters and acrylic polymers) with a second component containing both epoxy groups and ethylenic unsaturation e.g. glycidyl acrylate.

2—Urethane acrylates are those products formed by the reaction of an isocyanate containing component with a hydroxyl containing component. At least one of these components must contain ethylenic unsaturation. Examples of isocyanate functional components are hexamethylene diisocyanate, isophorone diisocyanate, isocyanate functional acrylic polymers and polyurethanes, reaction products of hydroxyl functional components (e.g. poly-ethylene glycol, poly-propylene glycol and di-, tri- and higher hydroxy functionality aliphatic alcohols (e.g. glycerol and trimethylolpropane) and their ethoxylated, propoxylated and polycaprolactone analogs) with di-, tri-and etcisocyanates (e.g. hexamethylene diisocyanate, isophorone diisocyanate and toluene diisocyanate (TDI)). Examples of hydroxy containing ethylenically unsaturated components are hydroxyethyl acrylate and its ethoxylated, propoxylated and polycaprolactone analogs

3—Multi-functional acrylate monomers are acrylic acid esters of di-, tri- and higher hydroxy functionality alcohols: e.g. polyethylene glycol, polypropylene glycol, aliphatic diols, neopentyl glycol, ethoxylated bisphenol A, trimethylolpropane, pentaerythritol, glycerol, di-trimethylolpropane, hydroxyl functional polyesters, dipentaerythritol and the ethoxylated, propoxylated and polycaprolactone analogs of all the above.

4—Amine-acrylate adducts are those products prepared by the partial “Michael Type Addition” of primary and secondary amines to ethylenic unsaturation i.e. the double bond of acrylate containing compounds. Of particular interest here are the multi-functional (meth)acrylate monomers as mentioned above. Examples of amine-acrylate adducts are diethylamine modified trimethylolpropane triacrylate and ethanolamine modified ethoxylated trimethylolpropane triacrylate.

5 to 8—Multifunctional acrylates of type 5 to 8 are considered as well known to a man skilled in the art, but some specifications are given here for a better illustration.

Polyester acrylates may be the reaction products of polyester polyols with acrylic acid. Polyalkoxylated polyolacrylates or polyether acrylates may be obtained by reacting acrylic acid with respectively polyalkoxylated (ethoxylated or/and propoxylated) polyols or polyether polyols (for example polyether based on ethoxy or/and propoxy repeating units). Acrylated acrylic oligomers may be the reaction products of acrylic oligomeric copolymers bearing epoxy groups (derived for example from glycidyl methacrylate) with acrylic acid. Acrylated oligomers of SMA or of S (M) AA may be obtained by at least partial esterification of anhydride or acid groups by an hydroxy alkyl acrylate (C₂-C₈ alkyl) . As an example of acrylated SMA we may mention the SARBOX® resins of SARTOMER.

All of the above listed acrylates may incorporate specific hydrophilic components to facilitate their being dissolved, emulsified or dispersed in an aqueous phase. Examples are the addition of secondary amines, phosphoric acid and anhydrides (e.g. succinic anhydride, phithalic anhydride and tetrahydrophthalic anhydride). The resulting tertiary amines and pendent carboxylic acid groups are then neutralised. Another hydrophilic group of particular interest is polyethylene glycol.

A particularly preferred multifunctional acrylate is ethoxylated trimethylolpropane triacrylate (Sartomer® 454 from Sartomer-Cray Valley Photocure) .

The solids content of the novel aqueous composition can be adjusted to give the desired viscosity. In general, the solids content is from 20 to 80, in particular from 20 to 70, % by weight. The particle size of the dispersion may vary from 50 to 150 nm.

The minimum film forming temperature (MFFT) of the novel aqueous composition is preferably<10° C., more preferably<7° C. That means that no coalescent agents are needed for the film formation at the temperatures usually encountered in the industrial radiation curing application lines.

The novel dispersions are particularly suitable as binders for coatings and coating material. Such coating compositions may contain further additives, for example pigments, dyes, fillers and assistants conventionally used in coating technology.

For radiation curing by UV light, photoinitiators are added to the dispersions. For curing by Electron Beam radiation no photoinitiator is required.

Examples of suitable photoinitiators are benzophenone, alkylbenzophenones, halomethylated benzophenones, Michler's ketone, 2-hydrozyacetophenone and halogenated benzoohenones. Benzoin and its derivatives are also suitable. Other effective photoinitiators are anthraquinone and many of its derivatives, for example, β-methylanthraquinone, tert-butylanthraquinone and anthraquinonecarboxylic esters and in particular acylphosphine oxides, eg. Lucirin® TP0 and Trgacure® B19.

The photoinitiators, depending on the intended use of the novel materials, may be used in amounts of from 0.1 to 15, preferably from 0.1 to 5, % by weight, based on the polymerizable components, and can be used as an individual substance or, owing to the frequent advantageous synergistic effects, also in combination with one another.

Advantageous additives which may lead to a further increase in the reactivity are certain tertiary amines, eg. N-methyldiethanolamine, triethylamine and triethanolamine as well as certain acrylated tertiary amines, eg. Craynor® 386 (Sartomer-Cray Valley Photocure).

The aqueous coating compositions may contain a thermal initiator if the coating is cured by heat or a catalyst if the coating is cured by auto-oxidation (redox mechanism). The thermal initiator is added to the composition from about 0.5% by weight of total non-volatiles (solids content) to about 2% by weight of total non-volatiles (solids content). Useful thermal initiators include azo compounds, such as azobisisobutyronitrile and the like, organic peroxides such as ketone peroxides, hydroperoxides, alkyl peroxides, acryl peroxides, peroxy esters and the like. Useful catalysts for auto-oxidative curing include the salts of cobalt, such as cobalt acetate, cobalt naphtenate and the like. Thermal initiators may be particularly useful for more efficient curing of coatings on substrates with surfaces or thicknesses presenting inaccessible zones or zones of low access to radiation curing. A thermal initiator may also be present alone for specific applications. In such a case, the thermal curing is applied under forced temperature conditions up to a temperature of 100° C., using for example iR (Infrared) or convection tunnels.

Another object of the invention concerns a process for preparing a composition according to the invention, comprising the step of mixing an aqueous dispersion of polymer (A), previously added with a volatile base in conditions to convert the said acetoacetoxy functions into enamine ones, with an aqueous predispersion of (B).

An additional subject concerns an aqueous coating composition comprising as a binder at least one aqueous composition defined according to the invention.

The novel aqueous polymer dispersion compositions can be used as aqueous binders for the production of industrial coatings.

These industrial coatings are used in the field of industrial wood finishing, joinery, wood and plastics coating and in inks. They can be applied with good adherence to substrates such as metal, plastic, glass, wood, paper, board, leather or textile, for example by spraying, pouring, roller coating, curtain coating, printing or knife coating.

More preferably the compositions of the present invention are curable after coating the said composition, by exposure of the said coating to radiation (UV/EB). For the step of radiation curing, the coatings are generally pre-heated for up to 30 minutes at up to 100° C. Some of the acetoacetoxy functional groups coming from the dispersed polymer which are blocked in the enamine form are released as the volatile base evaporates and they can react with a part of the acrylic double bonds of the multifunctional acrylate to give a Michael adduct. This secondary curing mechanism gives tack-free films before radiation curing. Afterwards the coatings are exposed for a short time to UV radiation or high energy electron radiation. The UV or electron radiation sources usually employed for curing coatings are used for this purpose.

More particularly a dual cure process for coating a substrate sureace comprises the following consecutive steps of:
(a) applying an aqueous coating composition of the invention to the substrate surface;
(b) pre-drying the coating to evaporate water and the volatile base by heating the said coating at a temperature in the range up to 100° C.; and
(c) curing the said coating by exposing it to radiation.

The present invention does also concern coated substrates obtained by using the coating compositions as defined accordingly.

The coatings obtained after UV curing have good sanding, good adherence to the substrate, high hardness and very good resistance to chemicals, this high performance being the result of the combination of two curing mechanisms: the one taking place before the radiation curing and the crosslinking of the remaining acrylic double bonds during the radiation exposure.

### EXAMPLES

### Example 1

The aqueous dispersion used contained:
(A) 87% by weight of a polymer of
   25% by weight of butyl-methacrylate;
   48% by weight of methyl-methacrylate;
   25% by weight of acetoacetoxyethyl-methacrylate; and
   2% by weight of acrylic acid;
   with a Tg of polymer (A): 54° C. (calculated according to Fox equation)
(B) 13% by weight of a predispersion at 75% by weight of ethoxylated (3 ethoxy units) trimethylolpropane triacrylate (Sartomer® 454 from Sartomer-Cray Valley Photocure) prepared by adding 75 parts by weight of the multifunctional acrylate to a solution of 3 parts by weight of sodium dioctyl sulphosuccinate in 22 parts by weight of deionized water.

The dispersion has
a solid content of 39.3%
a viscosity of 15.7 mpa.s (Brookfield LVT, 1/60 at 25° C.);
a pH of 8.61;
a particle size of 71.8 nm (Zetasizer 3000) ; and
a MFFT (Minimum Film Forming Temperature) of 6.3° C.

### Example 2

The aqueous dispersion used contained:
(A) 81% by weight of a polymer of
   69% by weight of methyl-methacrylate;
   4% by weight of butyl acrylate;
   25% by weight of acetoacetoxyethyl-methacrylate and
   2% by weight of acrylic acid;
   with a Tg of polymer (A) of 67° C. (conditions as for Example 1)
(B) 19% by weight of a predispersion at 75% by weight of ethoxylated (3 ethoxy units) trimethylolpropane triacrylate (Sartomer 454® from Sartomer-Cray Valley Photocure) prepared in a similar manner to the one described in the Example 1.

The dispersion has
a solid content of 91.4%
a viscosity of 23.5 mPa.s (Brookfield LVT, 1/60 at 25° C.);
a pH of 8.52;
a particle size of 71.2 nm (Zetasizer 3000); and
a MFFT of 0° C.

### Comparative Example 1

The aqueous dispersion used contained:
(A) 87% by weight of a polymer of
   55% by weight of butyl-methacrylate;
   43% by weight of methyl-methacrylate; and
   2% by weight of acrylic acid;
   with a Tg of polymer (A) of 53° C. (conditions as for Example 1).
(B) 13% by weight of a predispersion at 75% by weight of ethoxylated (3 ethoxy units) trimethylolpropane triacrylate (Sartomer 454® from Sartomer-Cray Valley Photocure) prepared in a similar manner to the one described in the Example 1.

The dispersion has
a solid content of 40.1%;
a viscosity of 22.5 mPa.s (Brookfield LVT, 1/60 at
25° C.);
a pH of 8.83
a particle size of 75.9 nm (Zetasizer 3000) ; and
a MFFT of +8.5° C.
   Procedure

The component (A) of the EXAMPLES 1-2 and the COMPARATIVE EXAMPLE 1 have been prepared by a multistage polymerization system, dividing the monomer content in 2 different parts, in a ratio of 30/70, with different Tgs, monomer polarity and different distribution of the acetoacetoxyethyl methacrylate, according to the specifications given in the Table 1 inserted below.

TABLE 1

| | EXAMPLES | | | | | |
|---|---|---|---|---|---|---|
| MONOMER COMPOSITION | 1 | | 2 | | Comp. 1 | |
| CORE (% over total monomer of A) | 30 | | 30 | | 30 | |
| MONOMER %: | % of A | % core | % of A | % core | % of A | % core |
| BUTYL-METHACRYLATE | 3.90 | 13 | — | — | 12.90 | 43 |
| METHYL-METHACRYLATE | 18.00 | 60 | 21.90 | 73 | 16.50 | 55 |
| AAEM | 7.50 | 25 | 7.50 | 25 | — | — |
| ACRYLIC ACID | 0.60 | 2 | 0.60 | 2 | 0.60 | 2 |
| TG (Fox eq.), ° C. | 64 | | 75.75 | | 63 | |
| SHELL (% over total monomer of A) | 70 | | 70 | | 70 | |
| MONOMER %: | % of A | % shell | % of A | % shell | % of A | % shell |
| BUTYL-METHACRYLATE | 21.00 | 30 | — | — | 42.00 | 60 |
| METHYL-METHACRYLATE | 30.10 | 43 | 47.60 | 68 | 26.60 | 38 |
| BUTYL ACRYLATE | — | — | 3.50 | 5 | — | — |
| AAEM | 17.50 | 25 | 17.50 | 25 | — | — |
| ACRYLIC ACID | 1.40 | 2 | 1.40 | 2 | 1.40 | 2 |

| | | | |
|---|---|---|---|
| TG (Fox eq.), ° C. | 49.8 | 66.2 | 49 |

The quantities are expressed for 100 parts of total monomer.
1—An initial charge containing 86.6 parts of deionised water and 5.6 parts of a 30% solution of disodium ethoxylated alcohol half ester of sulfosuccinic acid, was put in the reactor and heated to 80° C.
2—Once the initial charge had reached 80° C., the initial initiator solution (1.15 parts of water and 0.05 parts of sodium persulphate) was added.
3—After this, the first 30% of the monomers was added, in a constant rate during 1 hour, increasing the temperature to 84° C.
At the sane time, the initiation feeding (5.77 parts of water and 0.4 part of sodium, persulphate) was started. Added at a constant rate during 4 h 45 mn.
4—When finished first part of monomers, the reactor is maintained 30 minutes at 84° C.
5—A second part of monomers (70% of the total) is added to the reactor in preemulsion form with 20.8 parts of water and 7 parts of a 30% solution of disodium ethoxylated alcohol half ester of sulfosuccinic acid.
Time of feeding: 2 hours. The temperature is kept at 84° C. for 30 minutes more after finished the preemulsion.
6—A redox treatment composed by 0.1 part of tertiobutyl hydroperoxide (TBHP) and 0.1 part of sodium-formaldehyde-sulfoxylate (SFS) disolved in 2.3 parts of water, was added in 15 minutes, and maintained for 30 minutes more at 84° C.
7—The reactor was cooled to 55-60° C. before starting the neutralization step by adding in 15 minutes, a mixer of 2.08 parts of water and 2.08 parts of ammonia 25% until a constant pH of 8.0-8.2.
8—The reactor was cooled to below 40° C. before adding antifoam and biocide.
   Application

The dispersions prepared were mixed with 1.7% by weight, based on the solid, of Irgacure® 184 (Ciba) . Films of 100 wet microns were applied on glass using a doctor blade and were dried in an oven at 60° C. for 10 minutes. The films obtained were dry, clear and non tacky except for the one of the COMPARATIVE EXAMPLE 1 which was tacky. They were then exposed under a high pressure mercury lamp (80 W/cm) on a conveyor belt at a belt speed of 10 m/min (300 mJ/sqm of total UV dose).

Persoz hardness was measured before and after UV exposure. The following results were obtained

TABLE 2
Persoz hardness (seconds)

| | | | COMPARATIVE |
|---|---|---|---|
| | EXAMPLE 1 | EXAMPLE 2 | EXAMPLE 1 |
| Before UV | 99 | 134 | 88 |
| Exposure | | | |
| After UV exposure | 251 | 265 | 149 |

The coatings were also applied on wood (beech veneer). 2 coats of 80 g/sqm were applied by the following method:
1^{st} coat of 80 g/m²
Drying in oven for 10 minutes at 60° C.+UV curing
Sanding
2^{nd} coat of 80 g/m²
Drying in oven for 10 minutes at 60° C.+UV curing UV curing was performed using the same method as for the applications on glass.

The properties of the coatings after UV exposure are summarized in TABLE 3:

TABLE 3

| | | | COMPARATIVE |
|---|---|---|---|
| | EXAMPLE 1 | EXAMPLE 2 | EXAMPLE 1 |
| SANDABILITY* | 5 | 5 | 2 |
| CHEMICAL | | | |
| RESISTANCES | | | |
| (EN-12720)*: | | | |
| Water (16 h) | 5 | 5 | 5 |
| Water/ethanol | 5 | 5 | 5 |
| 1:1 (16 h) | | | |
| Ethanol (16 h) | 5 | 4 | 4 |
| Coffee (16 h) | 5 | 4 | 4 |
| Ammonia at | 4 | 5 | 1 |
| 10% in water (16 h) | | | |
| DBP** (16 h) | 4 | 5 | 1 |
| MEK*** (16 h) | 4 | 4 | 1 |
| Hand cream (16 h) | 5 | 5 | 2 |

*the best value is 5
**DBP: Dibutyl phthalate
***MEK: Methyl Ethyl Ketone

1. An aqueous polymer dispersion composition comprising for 100 parts by weight of (A)+(B):
(A) from 30 to 99 parts by weight of at least one dispersed polymer containing acetoacetoxy-type functional moieties, the said polymer having a glass transition temperature from 0 to 100° C.; and
(B) from 1 to 70 parts by weight of a multifunctional acrylate, said aqueous composition further containing a volatile base in an amount sufficient to convert the acetoacetoxy functionalities of (A) into enamine ones.

2. An aqueous composition as defined in claim 1 wherein the volatile base is ammonia.

3. An aqueous composition as defined in claim 1 wherein the pH of said composition is higher than 7.5 and up to 10.

4. An aqueous composition as defined in claim 1 wherein the acetoacetoxy-type functional moieties are derived from acetoacetoxyethyl methacrylate monomer incorporated in the polymer (A) by an emulsion polymerization process.

5. An aqueous composition as defined in 4claim 1 wherein the multifunctional acrylate (B) is the ethoxylated trimethylolpropane triacrylate.

6. An aqueous composition as defined in claim 1 with a MFFT<10° C.

7. A process for preparing a composition as defined in claim 1 comprising mixing an aqueous dispersion of polymer (A), previously added with a volatile base under such conditions to convert the said acetoacetoxy functions into enamine ones, with an aqueous pre-dispersion of (B).

8. An aqueous coating composition comprising as a binder at least one aqueous composition as defined in claim 1.

9. An aqueous composition according to claim 8 further comprising at least one of a photoinitiator, a thermal initiator or a catalyst for auto-oxidative curing.

10. A dual cure process for coating a substrate surface, which comprises the consecutive steps of:
(a) applying an aqueous coating composition, as defined in claim 9 to the said surface;
(b) pre-drying the coating to evaporate water and the volative base by heating the said coating at a temperature in the range up to 100° C.; and
(c) curing the said coating by exposing it to radiation.

11. An aqueous coating composition as defined in claim 8 adapted for use as an aqueous binder for industrial coatings in the field of industrial wood finishing, joinery, wood and plastics coating, floor polish or inks.

12. An aqueous coating composition as defined in claim 11 wherein the industrial coatings are applicable or applied to substrates selected from metal, plastic, glass, wood, paper, board, leather, textile, concrete, stone and derivatives.

13. Coated substrates resulting from use according to claim 12.

14. An aqueous composition as defined in claim 1 wherein the acetoacetylated polymer (A) has a content of acetoacetoxy functions from 0.14 to 1.87 expressed in mmol per gram of polymer (A).

15. An aqueous coating composition comprising as a binder at least one aqueous composition as defined in claim 8.

16. A dual cure process for coating a substrate surface of claim 10, which comprises the consecutive steps of:
(a) applying an aqueous coating composition, as defined in claim 10 to the said surface;
(b) pre-drying the coating to evaporate water and the volative base by heating the said coating at a temperature in the range up to 100° C.; and
(c) curing the said coating by exposing it to radiation.
